(19) United States
(12) Patent Application Publication
(10) Pub. No.: US 2001/0056409 A1
(43) Pub. Date: Dec. 27, 2001

(54) Offline one time credit card numbers for secure e-commerce

(76) Inventors: Steven Michael Bellovin, Westfield, NJ (US); Jeffrey Korn, New York, NY (US); Balachander Krishnamurthy, New York, NY (US)

Correspondence Address: Samuel H. Dworetsky, AT&T CORP., P.O. Box 4110, Middletown, NJ, 07748-4110, US

(21) Appl. No.: 09/855,908

(22) Filed: May 15, 2001

Related U.S. Application Data
(60) Provisional application No. 60/204,335, filed on May 15, 2000.

(51) Int. Cl. G06F 17/60

(52) U.S. Cl. 705/64

(57) ABSTRACT

It is an object of the invention to reduce the risk of misuse of a user's credit card number while avoiding having to securely contact and authenticate with a card-issuer before each transaction. In accordance with an aspect of the invention, the card-holder/user has access to a temporary authorization number generator, which is capable of accepting data from the user, such as the user's credit card number, and generating a cryptographically-secure temporary authorization number that is used in lieu of the user's credit card number in transactions. The card-issuer need not know the temporary authorization number before receiving the request for authorization from a merchant presented with it during a transaction. The present invention, while not limited to electronic commerce transactions, is especially suited for electronic commerce transactions occurring over a telecommunication network where the user cannot trust the integrity of either the network or the merchant receiving the credit card number.

### CROSS REFERENCE TO RELATED APPLICATIONS

This application claims priority to U.S. Provisional Application “Offline One Time Credit Card Numbers For Secure E-Commerce,” Ser. No. 60/204,335, filed on May 15, 2000, the contents of which are incorporated by reference herein.

### FIELD OF THE INVENTION

The invention relates to systems and methods for facilitating transactions using a credit card number, and more particularly to transactions that may be conducted over a telecommunication network.

### BACKGROUND OF THE INVENTION

The most pervasive payment mechanism today is the utilization of the multiple-use credit card. Users are typically issued a credit card number, conventionally of 15-16 digits, by a credit card issuer such as a bank. The user provides the credit card number and possibly some additional credentials, such as an identification card and a signature, and the merchant verifies the credit card with the bank's clearing house to authorize the transaction. The multiple-use credit card number is notoriously insecure. The number can be stolen by an eavesdropper or a malicious merchant and utilized to purchase items that are charged to the victim's account. Despite the unease felt by many in releasing credit card numbers over a telecommunication network, currently the most popular form of electronic commerce payment mechanism is still the use of a standard credit card number over a communication link secured by a protocol such as the Secure Sockets Layer. The problem again with this scenario is that a user must trust the security of the network against eavesdroppers and, more importantly, trust the merchant to protect the credit card number, which is an even more serious risk.

Alternative electronic commerce infrastructures such as the Secure Electronic Transactions protocol, see http://www.setco.org, have been seen as too complex and require the cooperation of too many different parties. Many users have resorted to using multiple credit card numbers—one number for general transactions, an alternative number only for electronic commerce transactions. U.S. Pat. No. 5,883,810, to Franklin et al., discloses a variation on this idea wherein users request additional “transaction” numbers from the credict card issuer for each new electronic transaction. The credit card issuer generates a new transaction number for the user and associates the transaction number with a real customer account number in a database record, which is checked when authorization for a particular merchant transaction is sought. Unfortunately, this scheme, as in the case of a user obtaining multiple conventional credit card numbers from an issuer, requires the user to directly contact the credit-card issuer before each transaction in order to obtain a new transaction number. Not only does this require some authenticated interaction with the credit card issuer before the transaction, the interaction must be secure from eavesdroppers.

### SUMMARY OF THE INVENTION

It is an object of the invention to reduce the risk of misuse of a user's credit card number while avoiding having to securely contact and authenticate with a card-issuer before each transaction in an “online” manner. In accordance with an aspect of the invention, the card-holder/user has access to a temporary authorization number generator, which may be embodied without limitation as an independent hardware/firmware device or as software executed on a personal computer or personal data assistant. The temporary authorization number generator is capable of accepting data from the user, such as the user's credit card number, and generating a cryptographically-secure temporary authorization number that is used in lieu of the user's credit card number in transactions. The card-issuer need not know the temporary authorization number before receiving the request for authorization from a merchant presented with it during a transaction. In accordance with an embodiment of the invention, the card-issuer and the card-holder share secret information that is used by the temporary authorization number generator in encrypting encoded data in the temporary authorization number, the data which is used to validate the transaction request.

In accordance with another embodiment of the invention, the temporary authorization number generator utilizes a cryptographic authentication function to generate a message authentication code, which only the card-issuer should be able to verify. In accordance with another embodiment of the invention, the temporary authorization number generator creates one-time passwords as temporary authorization numbers, which only the card-issuer is able to authenticate and verify. The present invention, while not limited to electronic commerce transactions, is especially suited for electronic commerce transactions occurring over a telecommunication network where the user cannot trust the integrity of either the network or the merchant receiving the credit card number.

These and other advantages of the invention will be apparent to those of ordinary skill in the art by reference to the following detailed description and the accompanying drawings.

### BRIEF DESCRIPTION OF THE DRAWINGS

FIG. 1 is an abstract diagram of a credit card transaction, illustrating a preferred aspect of the invention.

FIG. 2A, FIG. 3A, and FIG. 4A are flowcharts of processing performed in generating a temporary authorization number, in accordance with different illustrative embodiments of the invention.

FIG. 2B, FIG. 3B, and FIG. 4B are flowcharts of processing performed in validating a temporary authorization number, in accordance with different illustrative embodiments of the invention, corresponding to FIG. 2A, FIG. 3A, and FIG. 4A, respectively.

### DETAILED DESCRIPTION OF THE INVENTION

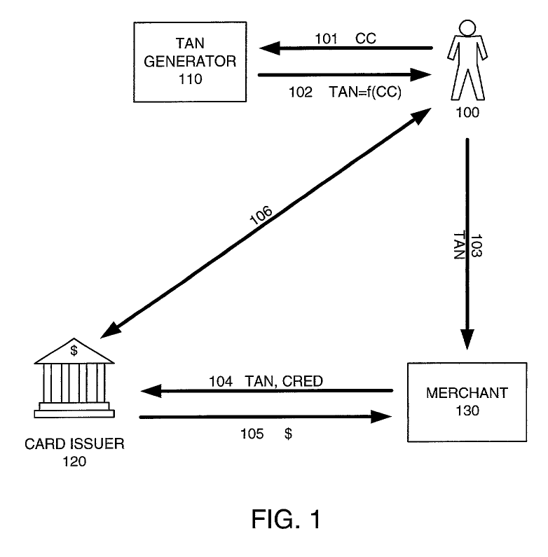

FIG. 1 is an abstract diagram of a credit card transaction. A user 100 has a credit card with a card issuer, typically a bank 120, and desires to conduct a transaction with merchant 130. The user is assumed to have a conventional credit card number (referred to as “CC” in FIG. 1), e.g. typically a 16 (or 15) digit number such as “1234 5678 9012 3456”. In accordance with an aspect of the invention, a user 100 has access to a temporary authorization number generator 110 which is capable of generating a temporary authorization number (“TAN”) as further described herein. The temporary authorization number is preferably a cryptographically secure number that may be utilized by the user 100 in lieu of the user's credit card number in the transaction with merchant 130. It is advantageous for the TAN to have the same (conceivably less but not preferably so) number of digits as a conventional credit card number to minimize changes to the existing commerce infrastructure. The temporary authorization number generator 110 can be readily implemented by any device or machine capable of accepting data, applying prescribed processes to the data, and supplying the results of the processes to the user 100. For example, and without limitation, the temporary authorization number generator 110 can be implemented as a computer program provided to the user 100 by the bank 120 for execution on the user's personal computer or hand-held personal digital assistant. Where the transaction is being conducted electronically over the Internet, it is advantageous to provide the temporary authorization number generator 110 as a software “plugin” for a conventional World Wide Web browser. Alternatively, the temporary authorization number generator 110 can be implemented as software on a server computer accessible to the user 100 via an appropriate client program such as a browser, as long as the communications between the client and the server are secured from eavesdropping. It is important to recognize that the bank 1 advantageously does not need access to the temporary authorization number that has been generated by the temporary authorization number generator 110—and, accordingly, the user 100 does not need to contact the bank 120 before the transaction.

As further described below, the temporary authorization number may be generated by the temporary authorization number generator 110 in a number of advantageous ways. With reference to the embodiment shown in FIG. 1, the user inputs the user's credit card number at step 101. At step 102, a temporary authorization number is generated from the user's credit card number (CC) under a bank-defined cryptographic function f, using keying material shared with or supplied by the bank 120. At step 103, the user 100 then sends the TAN=f(CC) to the merchant 130 instead of the credit card number. It should be noted that the user's interaction with the temporary authorization number generator 110 can be made transparent to the user 100. For example, where implemented as a Web browser plugin, the plugin can take the credit card number input by the user 100 and automatically generate and send the TAN to the merchant 130 in the context of known electronic commerce methodologies. Other than any interactions with the bank 120 required to establish the temporary authorization number generator 110, the user 100 can be oblivious to the remainder of the activities shown in FIG. 1. The merchant 130 then, at step 104, obtains authorization for payment for the transaction by sending the temporary authorization number—along with additional information such as the name of the user 100, the merchant's identification, etc.—to a clearing house for the bank 120. The bank clearing house 120, as further described herein, can then use information known to the bank to validate the transaction authorization number. At step 105, the clearing house can arrange for payment assuming that the temporary authorization number has been validated and has not previously been revoked by the user 100; the user 100 can then settle the transaction with the bank 1 at step 106.

Under the above transaction model, the user 100 only needs to trust the bank 120. The merchant 130 or any eavesdropper, depending on the cryptographic strength of the generator 110, will find it difficult to take advantage of exposure to the temporary authorization number. If the temporary authorization number is stolen, the bank 120 can deny authorization because the number is only valid for a specific transaction or a limited number of transactions. The invention is beneficial to users, who can make purchases without trusting the merchant. The invention is beneficial to merchants, especially merchants who transact over the Internet and who will gain additional customers reluctant to directly release credit card information over the network. The invention is beneficial to banks, who will experience reduced occurrences of fraud.

It should be noted that the above transaction model does not actually require, and is not limited to use of, a real credit card account number for the user 100 as set forth in FIG. 1. The merchant 130 and the bank 120 can use other user credentials such as the name and possibly address of the user 100 for verification purposes. It should also be noted that the transaction should be completed before the temporary authorization number can be invalidated by the user. This has implications for some merchants relating to the use of delayed charges. Some merchants validate a transaction by placing a nominal one dollar charge on the credit card, which merely serves to check the validity of the credit card. The transaction is not actually completed by sending the authorization code back to the bank. Thus, using the above transaction model, the merchant and the bank should ensure that the transaction completes before the user has an opportunity to invalidate the number used in the transaction.

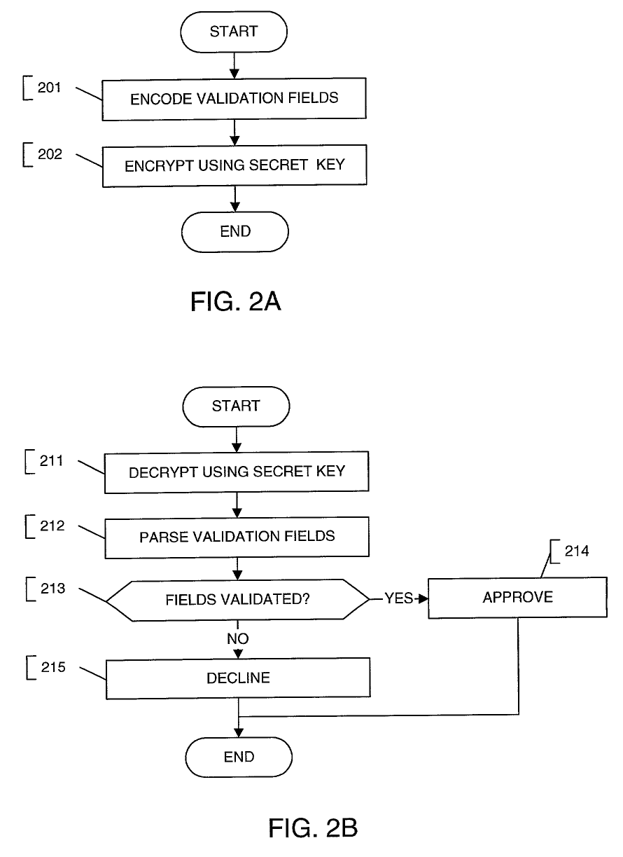

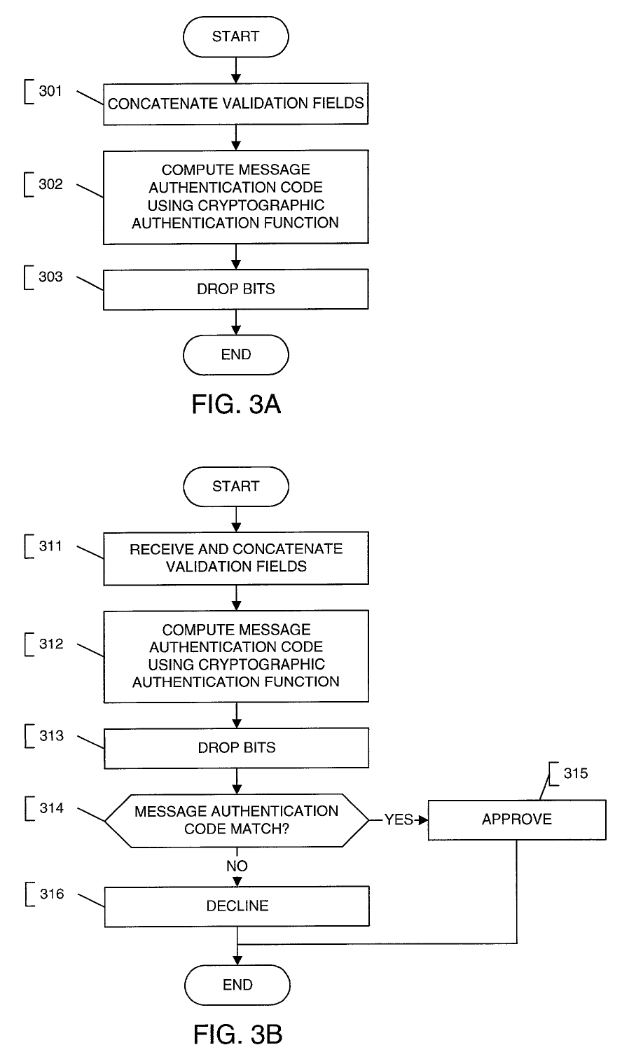

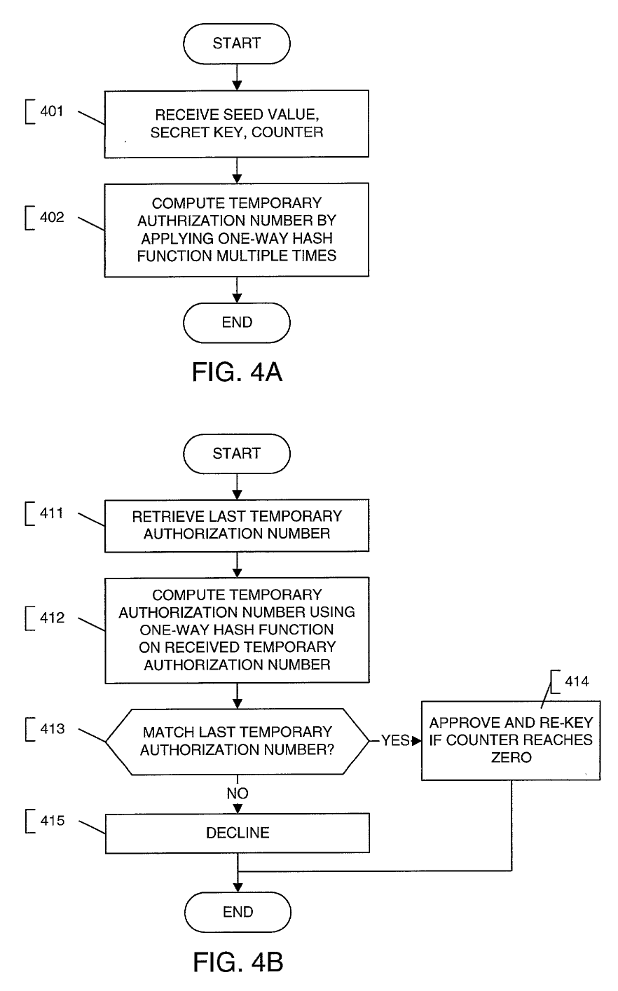

The potential for reuse of the temporary authorization number depends on the cryptographic strength of the method used to generate the temporary authorization number. Where the commerce infrastructure has been modified to accommodate temporary authorization numbers of arbitrary length, the methods utilized to generate and validate the number can broadly include a variety of known cryptographic techniques, such as use of an asymmetric public key infrastructure. Where, however, it is desired to keep the length of the temporary authorization number within the conventional 15-16 digit length for credit card numbers, there are a variety of practical constraints posed by the limited number of digits that may be exchanged. FIGS. 2, 3, and 4 illustrate a number of different practical schemes for generating and validating a temporary authorization number, particularly advantageous for handling this situation.

In FIG. 2A and 2B, the user is assumed to have a secret cryptographic key and a stored counter, which is also known to the bank. This information can, for example, be stored on the user's computer or PDA along with an optional instance number. The information can be protected however local policy suggests. The temporary authorization number generator proceeds as set forth in FIG. 2A. At step 201, some of the fields used by the bank to validate the transaction are encoded in a number used to generate the temporary authorization number. For example, assume that a customer provides a name, address, credit card number, and expiration date to a merchant for credit card verification. Assume further that the credit card number reflects a unique four-digit bank number plus one check digit, as is conventionally the case. That gives the temporary number generator ten digits, or 35 bits, to encode information useful for validation purposes. A useful encoding scheme is as follows:

19 BITS: Encode the transaction amount in pennies (this permits purchases of up to $5242.88, a reasonable limit for these sorts of transactions). 9 BITS: Encode the counter.

3 BITS: Distinguish among 8 different computers that share key.

REMAINING BITS: Encode some date information.

The encoded number is then encrypted, at step 202, using the secret cryptographic key. Any of a number of known methods of encryption can be utilized. The encrypted value can be the credit card number, as provided by the user. The counter is incremented with the creation of each new temporary authorization number. If the counter nears overflow, the user can be re-keyed and the counter reset. In addition, the expiration date of the credit card can reflect a real date indicating when the user has to be re-keyed.

FIG. 2B sets forth the processing performed by the bank's clearing house in validating the temporary authorization number generated in FIG. 2A. The bank receives the name and address associated with the temporary authorization number used in the transaction. The bank uses this information to look up the customer's record and secret cryptographic key. At step 211, the bank uses the secret key to decrypt the temporary authorization number. It does not matter if the name and address provided matches a number of possible customer records, as each cryptographic key associated with each possible matching record can be tried at step 211. At step 212, the different encoded fields are parsed from the resulting decrypted number. At step 213, the different fields can be checked to see if they match the other information known about the transaction. For example, the encoded amount is matched against the amount requested as payment by the merchant. The date, if given, is matched against the settlement date, possibly to within a day or two. The counter field is checked by the bank to see if it is unique. The bank can verify the counter by maintaining minimal state information, e.g. a high water mark for the counter and a bit mask for the last sixteen used counters. If the bank validates the encoded fields, the temporary authorization number and the transaction is approved at step 214—otherwise the transaction is declined at step 215.

In FIG. 3A and 3B, an alternative scheme is illustrated that takes advantage of cryptographic authentication functions. This scheme is suspected by the inventors to be stronger than the scheme illustrated in FIG. 2A and 2B. The user is again assumed to have a secret cryptographic key, a stored counter, and an optional instance number. The temporary authorization number generator proceeds as set forth in FIG. 3A. At step 301, some or all of the information used to validate the temporary authorization number is concatenated. For example, the counter, the instance number, the amount of the transaction, and the user's name and address can be concatenated into a string. If there is room, the merchant's name and the date of the transaction can also be included. At step 302, the string and the secret cryptographic key are utilized to compute a message authentication code (MAC) using any of a number of known cryptographic authentication functions. See, e.g., Krawczyk et al., “HMAC: Keyed-Hashing for Message Authentication,” IETF RFC 2104, Network Working Group 1997, which is incorporated by reference herein. For example, an HMAC can be constructed with the string and the secret key as set forth in RFC 2104 using any iterated cryptographic hash function such as MD5 or SHA-1. At step 303, as may bits of the message authentication code as can fit in the temporary authorization number are utilized—with the remaining bits dropped. FIG. 3B sets forth the processing performed by the bank's clearing house in validating the temporary authorization number generated in FIG. 3A. The bank uses the information it has in its possession to recreate the message authentication code. The bank receives the name and address associated with the temporary authorization number used in the transaction, and, as before, uses this information to look up the customer's record and secret cryptographic key. At step 311, the bank attempts to recreate the string for the message authentication code by receiving and concatenating the validation fields used for the message authentication code: e.g., the amount of the transaction, the user's name and address, etc. At step 312, the bank uses the secret cryptographic key and the string to compute another message authentication code using the same cryptographic authentication function used by the temporary authorization number generator in FIG. 3A. Any bits dropped at step 303 in FIG. 3A are also dropped at step 313 in FIG. 3B, as agreed upon beforehand. The generated message authentication code is matched at step 314 against the message authentication code received in the temporary authorization number. Where a message authentication code of a length of 13 bits is used, this will mean that the chance of a successful random string succeeding should be one in 2ˆ 26. If the bank validates the encoded fields, the temporary authorization number and the transaction is approved at step 315—otherwise the transaction is declined at step 316.

In FIG. 4A and 4B, an alternative scheme is illustrated that is based on a particularly advantageous one-time password scheme, although other one-time password schemes may also be used. See, e.g., Hailer, “The S/Key One-Time Password System,” IETF RFC 1760, Network Working Group 1995, which is incorporated by reference herein. This scheme is suspected to be not as secure as the scheme illustrated in FIG. 3A and 3B, but does provide a very different alternative. In FIG. 4A, the temporary authorization number generator creates a sequence of one-time passwords by applying a secure one-way hash function multiple times to the output of a preparatory step. At step 401, the temporary authorization number generator receives the information needed for the preparatory step, which requires some secret key/pass phrase which may be based on some user credentials such as the user's credit card number. It is also advantageous for the temporary authorization number generator to receive a seed value, which may be transmitted from the card-issuer in plaintext and which is concatenated with the secret key. The result, after processing such as hashing and reduction to an appropriate bit size, is passed through the one-way hash function a number of times equal to a counter, at step 402. With each new temporary authorization number generated, the counter is decremented. The bank's clearing house processes the temporary authorization number, as illustrated in FIG. 4B. The bank stores in the user's account a copy of the last temporary authorization number utilized by the user, which is retrieved at step 411. The system can be initialized with the first temporary authorization number in the sequence and a counter initialized to the same value as on the generator side. To verify a temporary authorization number received from a merchant, at step 412, the bank merely passes the received temporary authorization number through the one-way hash function and compares the result to the stored temporary authorization number. If the result of the hash function matches the stored previous authorization number, at step 413, the temporary authorization number is approved at step 414—otherwise, it is declined at 415. The received temporary authorization number is stored for use in the next verification process, and the counter decremented. At some point, when the counter reaches zero, the system should be reinitialized, e.g. by creating a new secret key, count, and/or seed. It will be readily recognized that, although described with regard to a particular one-time password scheme, the present invention may be readily extended to utilizing other one-time password schemes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention.

What is claimed is:

1. A method for facilitating credit card transactions, comprising the steps of:
receiving from a merchant, desiring to receive authorization for a transaction with a user having an account with a credit card issuer, a transaction authorization number and information regarding the transaction;
retrieving secret information shared with a transaction authorization number generator utilized by the user; and
verifying the temporary authorization number by using the shared secret information and information regarding the transaction.

2. The invention of claim 1 wherein the secret information further comprises a credit card number associated with the user.

2. The invention of claim 1 wherein the secret information is utilized as a cryptographic key to decrypt information regarding the transaction encoded in the temporary authorization number.

3. The invention of claim 1 wherein the temporary authorization number is a message authentication code generated from the information regarding the transaction using the secret information as a cryptographic key.

4. The invention of claim 1 wherein the temporary authorization number is a one-time password generated from the shared secret information.

5. A method for facilitating credit card transactions, comprising the steps of:
receiving authentication information from a user having an account with a credit card issuer; and
generating a temporary authorization number for the user using secret information shared with a credit card issuer whereby the temporary authorization number may be utilized in a transaction and verified by the credit card issuer using the shared secret information and information regarding the transaction.

6. The invention of claim 5 wherein the secret information further comprises a credit card number associated with the user which is also used as the authentication information.

7. The invention of claim 5 wherein the secret information is utilized as a cryptographic key to decrypt information regarding the transaction encoded in the temporary authorization number.

8. The invention of claim 5 wherein the temporary authorization number is a message authentication code generated from the information regarding the transaction using the secret information as a cryptographic key.

9. The invention of claim 5 wherein the temporary authorization number is a one-time password generated from the shared secret information.

10. The invention of claim 5 wherein the temporary authorization number has a format similar to a credit card number.

11. A processor readable medium containing executable program instructions for performing a method on a device comprising the steps of:
receiving authentication information from a user having an account with a credit card issuer; and
generating a temporary authorization number for the user using secret information stored on the device and shared with a credit card issuer whereby the temporary authorization number may be utilized in a transaction and verified by the credit card issuer using the shared secret information and information regarding the transaction.

12. The invention of claim 5 wherein the secret information further comprises a credit card number associated with the user which is also used as the authentication information.

13. The invention of claim 5 wherein the secret information is utilized as a cryptographic key to decrypt information regarding the transaction encoded in the temporary authorization number.

14. The invention of claim 5 wherein the temporary authorization number is a message authentication code generated from the information regarding the transaction using the secret information as a cryptographic key.

15. The invention of claim 5 wherein the temporary authorization number is a one-time password generated from the shared secret information.

16. The invention of claim 5 wherein the temporary authorization number has a format similar to a credit card number.
